(19) United States
(12) Patent Application Publication
(10) Pub. No.: US 2009/0237357 A1
(43) Pub. Date: Sep. 24, 2009

(54) Method And Cursor-Generating Device For Generating A Cursor Extension On A Screen Of An Electronic Device

(76) Inventors: Chueh-Pin Ko, Taipei Hsien (TW); Jiann-Jou Chen, Taipei Hsien (TW)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/208,871

(22) Filed: Sep. 11, 2008

(30) Foreign Application Priority Data
Mar. 24, 2008 (TW) 097110350

(51) Int. Cl. G06F 3/033; G06F 3/041

(52) U.S. Cl. 345/157; 345/173

(57) ABSTRACT

A method for generating a cursor extension on a screen of an electronic device includes the steps of detecting presence of at least one touched spot on a touchpad of the electronic device, and deciding whether to generate the cursor extension based on an attribute of the at least one detected touched spot. A cursor-generating device that performs the method is also disclosed.

### CROSS-REFERENCE TO RELATED APPLICATION

This application claims priority of Taiwanese application no. 097110350, filed on Mar. 24, 2008.

### BACKGROUND OF THE INVENTION

1. Field of the Invention

This invention relates to a method and cursor-generating device for generating a cursor extension on a screen of an electronic device.

2. Description of the Related Art

A conventional electronic device, which includes a touchscreen, allows selection of an object, such as an icon or a menu item, displayed on the touchscreen with the use of a stylus or the user's finger. Many users prefer to use their fingers to save the time and effort required to retrieve and handle the stylus. However, selection of the objects with the use of a finger is slow and is error prone. Two pointing techniques have been proposed heretofore to address these issues.

In the first pointing technique, as illustrated in FIG. 1, when a tip of a user's finger 1 is detected on a touchscreen (not shown), and when the tip of the user's finger 1 overlaps multiple objects 11, a cursor extension 10 is generated on the touchscreen, which thereafter may be moved to select one of the objects 11.

In the second pointing technique, called Shift, as illustrated in FIG. 2, when a tip of a user's finger 1 is detected on a touchscreen (not shown), and when the tip of the user's finger 1 overlaps multiple objects 11, a window 20 is generated on the touchscreen. The window 20 shows the overlapped objects, and a cursor extension 21, which thereafter may be moved to select one of the objects, e.g., the object 22, shown in the window 20.

The aforementioned two conventional pointing techniques are disadvantageous in that the tip of the user's finger 1 has to be moved along the touchscreen in order to move the cursor extension 11, 21. Moreover, the two conventional pointing techniques do not resolve the issue of the difficulty in selecting an object on the edge of the touchscreen.

### SUMMARY OF THE INVENTION

Therefore, the main object of the present invention is to provide a method for generating a cursor extension on a screen of an electronic device that can overcome the aforesaid drawbacks of the prior art.

Another object of the present invention is to provide a cursor-generating device for generating a cursor extension on a screen of an electronic device that can overcome the aforesaid drawbacks of the prior art.

According to an aspect of the present invention, a method for generating a cursor extension on a screen of an electronic device comprises the steps of:

A) detecting presence of at least one touched spot on a touchpad of the electronic device; and

B) deciding whether to generate the cursor extension based on an attribute of the at least one touched spot detected in step A).

According to another aspect of the present invention, a cursor-generating device is adapted for generating a cursor extension on a screen of an electronic device, and comprises a detecting unit that is adapted to be coupled to a touchpad of the electronic device and that is operable so as to detect presence of at least one touched spot on the touchpad, and a processing unit that is coupled to the detecting unit, that is adapted to be coupled to the screen, and that is operable so as to decide whether to enable generation of the cursor extension on the screen based on an attribute of the at least one touched spot detected by the detecting unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a conventional pointing technique for generating and moving a cursor extension;

FIG. 2 is a schematic diagram illustrating another conventional pointing technique for generating and moving a cursor extension;

FIG. 3 is a block diagram of the preferred embodiment of a cursor-generating device according to this invention;

FIG. 4 is a schematic diagram illustrating a cursor extension generated by the preferred embodiment;

FIGS. 5A to 5C are flow charts of the preferred embodiment of a method for generating a cursor extension to be implemented using the cursor-generating device shown in FIG. 3 according to this invention;

FIGS. 6 to 9 are schematic diagrams illustrating states where a cursor extension is generated; and

FIGS. 10 to 12 are schematic diagrams illustrating states where the cursor extension is moved.

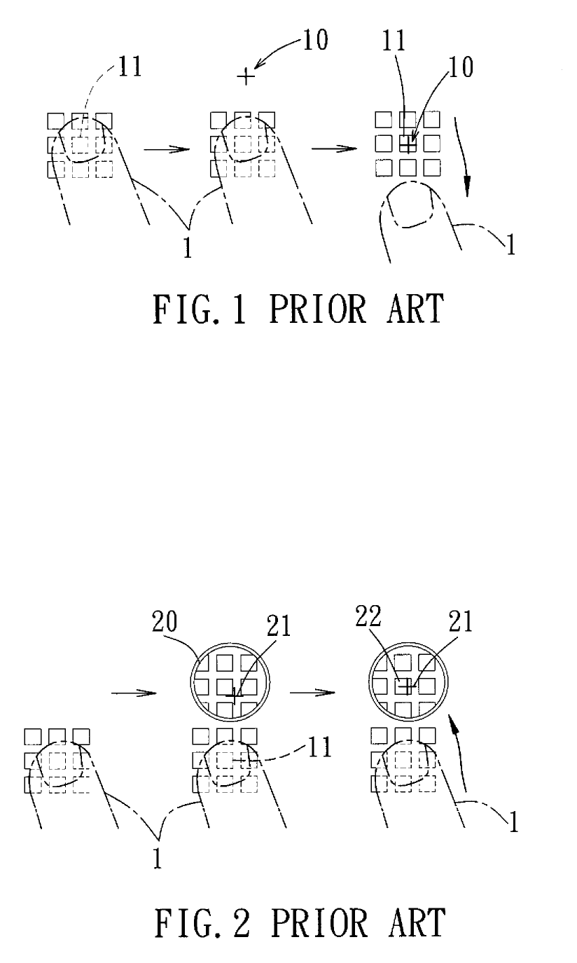

### DETAILED DESCRIPTION OF THE PREFERRED EMBODIMENT

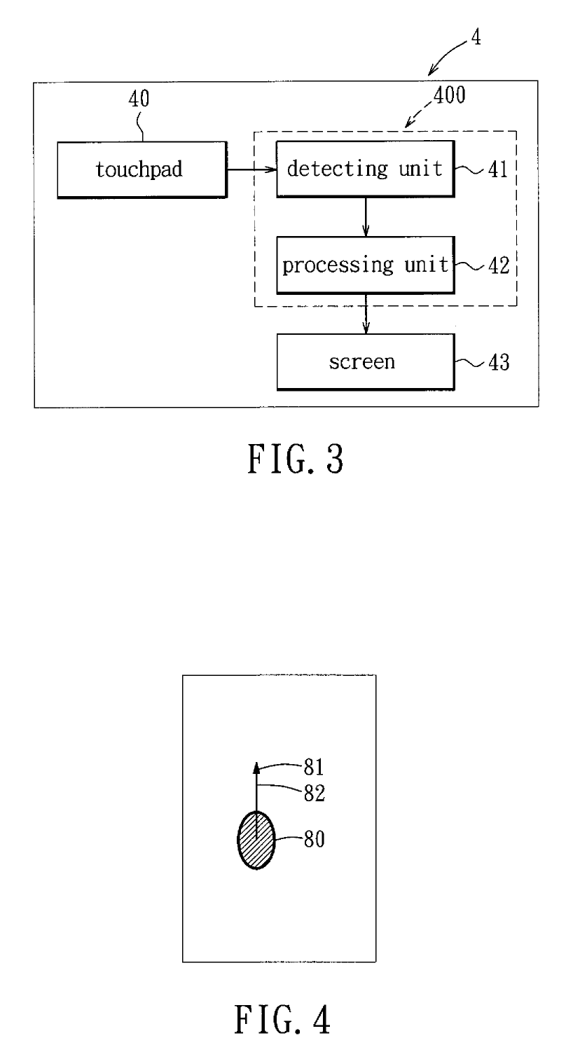

Referring to FIGS. 3 and 4, the preferred embodiment of a cursor-generating device 400 according to this invention is shown to include a detecting unit 41 and a processing unit 42.

The cursor-generating device 400 of this invention is applicable to an electronic device 4 that includes a screen 43, such as a liquid crystal display (LCD), and a touchpad 40, such as a planar or a non-planar capacitive touchpad.

The electronic device 4 may be a notebook computer, a personal digital assistant (PDA), a mobile phone, or a global positioning system (GPS).

The cursor-generating device 400 is used to generate a cursor extension on the screen 43 to thereby assist a user of the touchpad 40 to select an object (not shown) (e.g., a key of a virtual keyboard, an icon, an item in a menu, etc.) displayed on the screen 43.

In this embodiment, the screen 43 and the touchpad 40 constitute a touchscreen. That is, the touchpad 40 is mounted on the screen 43. In an alternative embodiment, the screen 43 and the touchpad 40 are separated from each other.

The detecting unit 41 is connected electrically to the touchpad 40, and is operable so as to detect presence of at least one touched spot 80 impressed by a user's finger on the touchpad 40. In this embodiment, the detecting unit 41 is a touch controller implemented in a hardware circuit.

The processing unit 42, which includes a microprocessor (not shown), is connected electrically to the detecting unit 41 and the screen 43, and is operable so as to decide whether to enable generation of a cursor extension on the screen 43 based on an attribute of the at least one touched spot 80 detected by the detecting unit 41, in a manner that will be described hereinafter.

In this embodiment, the cursor extension generated on the screen 43 includes a symbol 81, and a line 82 that extends between the symbol 81 and a position on the screen 43 that corresponds to the touched spot 80 detected by the detecting unit 41.

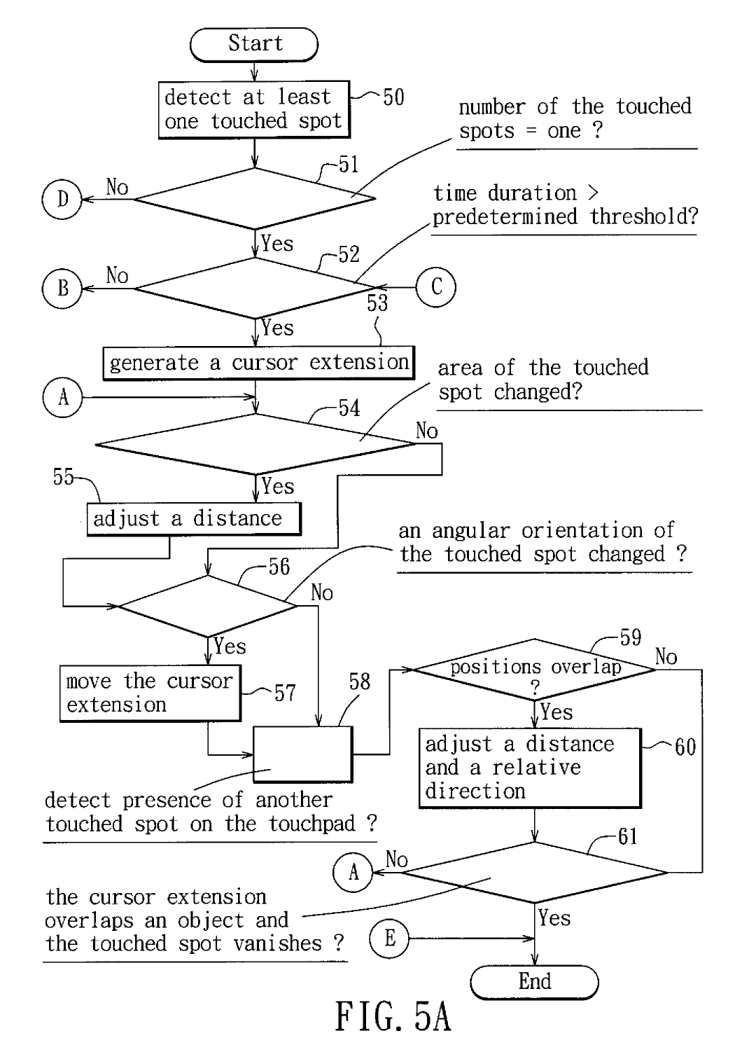

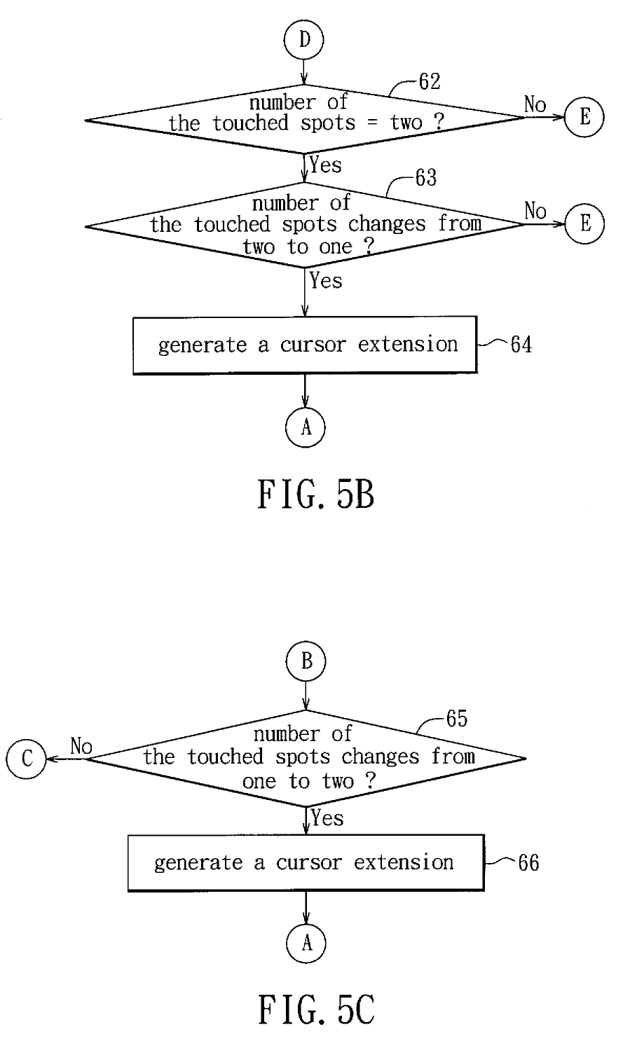

The preferred embodiment of a method for generating the cursor extension to be implemented using the aforementioned cursor-generating device 400 according to this invention will now be described with further reference to FIGS. 5A to 5C.

In step 50, the detecting unit 41 detects at least one touched spot 80 on the touchpad 40 of the electronic device 4. Thereafter, the detecting unit 41 sends coordinates of the at least one touched spot 80 detected thereby to the processing unit 42.

In step 51, when the processing unit 42 determines that the number of the touched spots 80 on the touchpad 40 detected in step 50 is one, the flow proceeds to step 52. Otherwise, the flow proceeds to step 62.

In step 52, when the processing unit 42 determines that the touched spot 80 detected in step 50 remains on the touchpad 40 for a time duration that exceeds a predetermined threshold, e.g., two seconds, the flow proceeds to step 53. Otherwise, the flow proceeds to step 65.

In this step, the processing unit 42 activates a timer (not shown) that measures the time duration within which the touched spot 80 remains on the touchpad 40 upon receipt of the coordinates of the touched spot 80 sent by the detecting unit 41.

In step 53, the processing unit 42 generates a cursor extension. Thereafter, the flow proceeds to step 54.

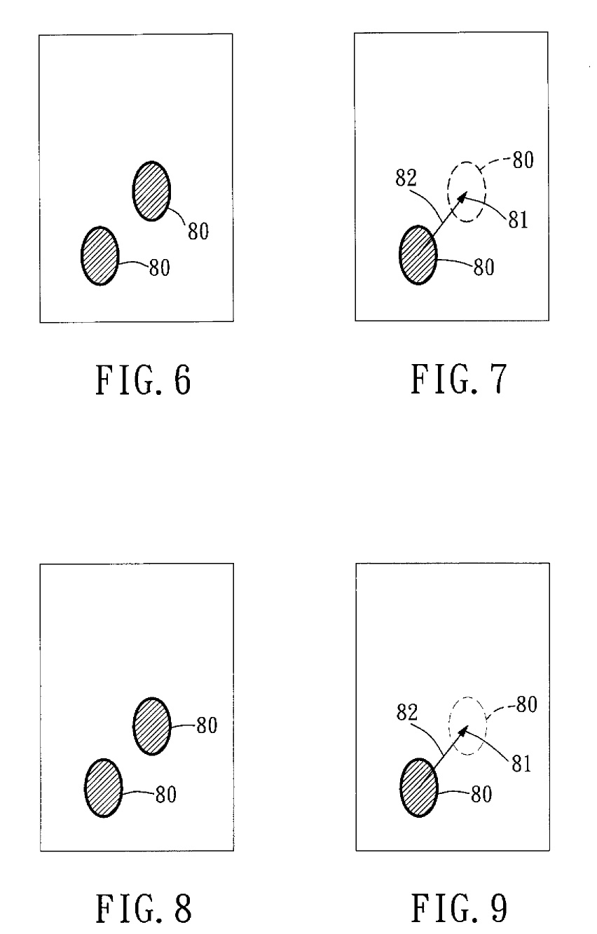

In step 62, as illustrated in FIG. 6, when the processing unit 42 determines that the number of the touched spots 80 on the touchpad 40 detected in step 50 is two, the flow proceeds to step 63. Otherwise, the flow is terminated.

In step 63, when the processing unit 42 determines that the number of the touched spots 80 on the touchpad 40 detected in step 50 changes from two to one, i.e., one of the touched spots 80 vanishes, and that the change in the number of the touched spots 80 on the touchpad 40 occurs within a predetermined time period, e.g., one second, the flow proceeds to step 64. Otherwise, the flow is terminated.

In step 64, the processing unit 42 generates the cursor extension. Thereafter, the flow proceeds to step 54.

In this step, as illustrated in FIG. 7, the cursor extension is generated at a position on the screen 43 that corresponds to a vanished one of the touched spots 80, and is manipulated through a remaining one of the touched spots 80 on the touchpad 40.

In step 65, as illustrated in FIG. 8, when the processing unit 42 determines that the number of the touched spots 80 on the touchpad 40 detected in step 50 changes from one to two, the flow proceeds to step 66. Otherwise, the flow proceeds to step 52.

In step 66, the processing unit 42 generates the cursor extension. Thereafter, the flow proceeds to step 54.

In this step, as illustrated in FIG. 9, the cursor extension is generated at a position on the screen 43 that corresponds to an initial one of the touched spots 80 detected in step 50 and is manipulated through a latter one of the touched spots 80 detected in step 50.

In step 54, when the processing unit 42 determines a change in an area of the touched spot 80 detected in step 50 on the touchpad 40, the flow proceeds to step 55. Otherwise, the flow proceeds to step 56.

For example, in this step, the processing unit 42 may determine an increase or a decrease of approximately 10 mm² from the previous area of the touched spot 80 on the touchpad 40.

In step 55, the processing unit 42 adjusts a distance between the symbol 81 of the cursor extension generated in step 53, 64, or 66 and a position on the screen 43 that corresponds to the touched spot 80 detected in step 50 on the touchpad 40 based on the change in the area of the touched spot 80 determined in step 54.

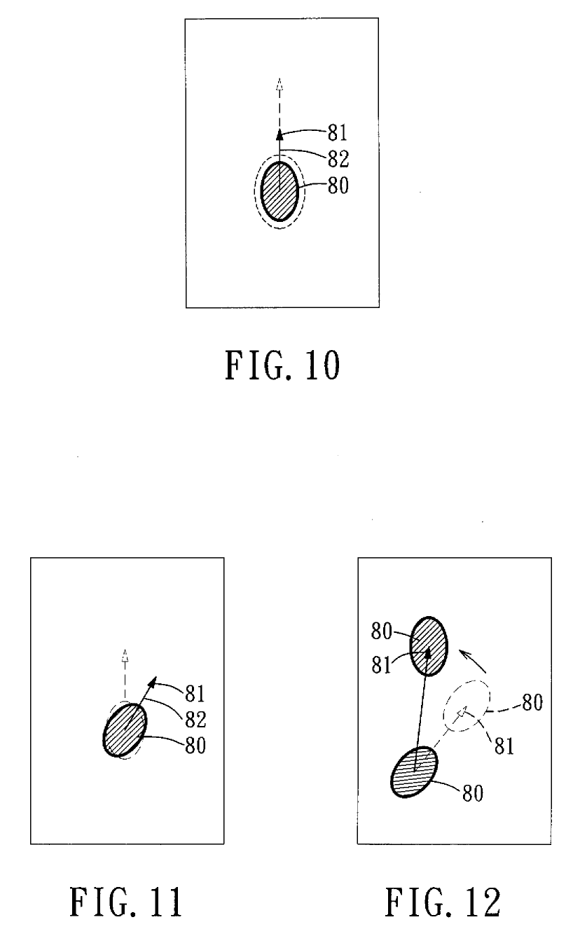

In this step, as illustrated in FIG. 10, the processing unit 42 lengthens or shortens the line 82 of the cursor extension to thereby adjust the distance between the symbol 81 of the cursor extension and the position on the screen 43 that corresponds to the touched spot 80.

In step 56, when the processing unit 42 determines a change in an angular orientation of the touched spot 80 detected in step 50 on the touchpad 40, the flow proceeds to step 57. Otherwise, the flow proceeds to step 58.

For example, in this step, the processing unit 42 may determine a 20-degree change in the angular orientation of the touched spot 80 on the touchpad 40.

In step 57, the processing unit 42 moves the cursor extension generated in step 53, 64, or 66 in a direction that corresponds to the change in the angular orientation of the touched spot 80 determined in step 56. Thereafter, the flow proceeds to step 58.

For example, as illustrated in FIG. 11, the processing unit 42 may change the direction of the cursor extension by 20 degrees or a multiple of 20 degrees, such as 100 degrees.

In step 58, the detecting unit 41 detects presence of another touched spot 80 on the touchpad 40.

In step 59, when the processing unit 42 determines that a position on the screen 43 that corresponds to the touched spot 80 detected in step 58 overlaps a position of the cursor extension generated in step 53, 64, or 66, the flow proceeds to step 60. Otherwise, the flow proceeds to step 61.

In step 60, the processing unit 42 adjusts a distance and a relative direction between the cursor extension generated in step 53, 64, or 66 and a position on the screen 43 that corresponds to the touched spot 90 detected in step 50 based on the touched spot 80 detected in step 58.

For example, as illustrated in FIG. 12, when the processing unit 42 determines that the touched spot 80 detected in step 58 is moved upwardly toward the left, the processing unit 42 moves the symbol 81 of the cursor extension to a position on the screen 43 that corresponds to the touched spot 80 detected in step 58.

In step 61, when the processing unit 42 determines that the cursor extension overlaps an object and that the touched spot 80 detected in step 50 vanishes, the flow is terminated. Otherwise, the flow goes back to step 54.

It is noted that, in this embodiment, aside from the time duration within which the touched spot 80 detected in step 50 remains on the touchpad 40 and the change in the number of the touched spots 80 detected in step 50, the cursor extension is likewise generated when an area of the touched spot 80 detected in step 50 exceeds a corresponding predetermined threshold.

Furthermore, in an alternative embodiment, instead of a capacitive touchpad, the touchpad 40 of the electronic device 4 may be an optical touchpad. In this case, the optical touchpad 40 captures an image of a touched spot 80 thereon, which is thereafter detected by the detecting unit 41. The processing unit 42 may adjust a distance between a cursor extension generated on the screen 43 and a position on the screen 43 that corresponds to the touched spot 80 on the touchpad 40 based on the change in an area of the image of the touched spot 80 detected by the detecting unit 41. In addition, the processing unit 42 may move the cursor extension generated on the screen 43 in a direction that corresponds to an angular orientation of the image of the touched spot 80 detected by the detecting unit 41.

It has thus been shown that, unlike the conventional pointing techniques, which require movement of a user's finger along a touchscreen in order to move a cursor extension, this invention permits movement of the cursor extension by simply changing an angular orientation of the touched spot 80 on the touchpad 40 and varying an area of the touched spot 80 on the touchpad 40. As such, selection of objects displayed on the screen 43, even those objects that are on the edge of the screen 43, is relatively easy, fast, and accurate.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for generating a cursor extension on a screen of an electronic device, the electronic device further including a touchpad, said method comprising the steps of:
A) detecting presence of at least one touched spot on the touchpad of the electronic device; and
B) deciding whether to generate the cursor extension based on an attribute of the at least one touched spot detected in step A).

2. The method as claimed in claim 1, wherein the cursor extension is generated in step B) when the touched spot detected in step A) remains on the touchpad for a time duration that exceeds a predetermined threshold.

3. The method as claimed in claim 1, further comprising the steps of:
C) determining a change in area of the touched spot detected in step A) on the touchpad; and
D) adjusting a distance between the cursor extension generated in step B) and a position on the screen that corresponds to the touched spot detected in step A) based on the change in the area of the touched spot determined in step C).

4. The method as claimed in claim 1, further comprising the steps of:
C) detecting presence of another touched spot on the touchpad;
D) determining whether a position on the screen that corresponds to the touched spot detected in step C) overlaps a position of the cursor extension generated in step B); and
E) when it is determined in step D) that the position on the screen that corresponds to the touched spot detected in step C) overlaps the position of the cursor extension, adjusting a distance and a relative direction between the cursor extension generated in step B) and the position on the screen that corresponds to the touched spot detected in step A) based on the touched spot detected in step C).

5. The method as claimed in claim 1, further comprising the steps of:
C) determining a change in an angular orientation of the touched spot detected in step A) on the touchpad; and
D) moving the cursor extension generated in step B) in a direction that corresponds to the change in the angular orientation of the touched spot determined in step C).

6. The method as claimed in claim 1, wherein the cursor extension is generated in step B) when the number of the touched spots on the touchpad detected in step A) changes from one to two.

7. The method as claimed in claim 6, wherein the cursor extension is generated in step B) at a position on the screen that corresponds to an initial one of the touched spots detected in step A) and is manipulated through a latter one of the touched spots detected in step A).

8. The method as claimed in claim 6, wherein the change in the number of the touched spots on the touchpad occurs within a predetermined time period.

9. The method as claimed in claim 7, wherein, when it is determined that a position on the screen that corresponds to the latter one of the touched spots overlaps a position of the cursor extension generated in step B), a distance and a relative direction between the cursor extension generated in step B) and the position on the screen that corresponds to the initial one of the touched spots are adjusted based on the latter one of the touched spots.

10. The method as claimed in claim 1, wherein the cursor extension is generated in step B) when the number of the touched spots on the touchpad detected in step A) changes from two to one.

11. The method as claimed in claim 10, wherein the cursor extension is generated in step B) at a position on the screen that corresponds to a vanished one of the touched spots, and is manipulated through a remaining one of the touched spots on the touchpad.

12. The method as claimed in claim 11, wherein a distance between the cursor extension generated in step B) and a position of the screen that corresponds to the remaining one of the touched spots is adjusted based on a change in an area of the remaining one of the touched spots on the touchpad.

13. The method as claimed in claim 1, wherein the cursor extension is generated in step B) when an area of the touched spot detected in step A) on the touchpad exceeds a predetermined threshold.

14. The method as claimed in claim 13, further comprising the steps of:
C) determining a change in the area of the touched spot detected in step A) on the touchpad; and
D) adjusting a distance between the cursor extension generated in step B) and a position on the screen that corresponds to the touched spot detected in step A) based on the change in the area of the touched spot determined in step C).

15. The method as claimed in claim 1, wherein the cursor extension generated in step B) includes a symbol, and a line that extends between the symbol and a position on the screen that corresponds to the touched spot detected in step A).

16. A cursor-generating device adapted for generating a cursor extension on a screen of an electronic device, the electronic device further including a touchpad, said cursor-generating device comprising:
a detecting unit adapted to be coupled to the touchpad and operable so as to detect presence of at least one touched spot on the touchpad; and
a processing unit coupled to said detecting unit, adapted to be coupled to the screen, and operable so as to decide whether to enable generation of the cursor extension on the screen based on an attribute of the at least one touched spot detected by said detecting unit.

17. The cursor-generating device as claimed in claim 16, wherein said processing unit enables generation of the cursor extension on the screen when the touched spot detected by said detecting unit remains on the touchpad for a time duration that exceeds a predetermined threshold.

18. The cursor-generating device as claimed in claim 17, wherein said processing unit is further operable so as to adjust a distance between the cursor extension generated on the screen and a position on the screen that corresponds to the touched spot detected by said detecting unit based on a change in an area of the touched spot on the touchpad.

19. The cursor-generating device as claimed in claim 17, wherein said processing unit is further operable so as to enable movement of the cursor extension generated on the screen in a direction that corresponds to a change in an angular orientation of the touched spot detected by said detecting unit on the touchpad.

20. The cursor-generating device as claimed in claim 17, wherein said processing unit is further operable so as to adjust a distance and a relative direction between the cursor extension generated on the screen and a position on the screen that corresponds to an initial one of the touched spots detected by said detecting unit based on a latter one of the touched spots detected by said detecting unit on the touchpad when said processing unit determines that a position on the screen that corresponds to the latter one of the touched spots on the touchpad overlaps a position of the cursor extension on the screen.

21. The cursor-generating device as claimed in claim 16, wherein said processing unit enables generation of the cursor extension on the screen when the number of the touched spots on the touchpad detected by said detecting unit changes from one to two.

22. The cursor-generating device as claimed in claim 21, wherein said processing unit enables generation of the cursor extension at a position on the screen that corresponds to an initial one of the touched spots detected by said detecting unit, and further enables manipulation of the cursor extension through a latter one of the touched spots detected by said detecting unit.

23. The cursor-generating device as claimed in claim 22, wherein said processing unit is further operable so as to adjust a distance between the cursor extension generated on the screen and a position on the screen that corresponds to the latter one of the touched spots based on a change in an area of the latter one of the touched spots on the touchpad.

24. The cursor-generating device as claimed in claim 21, wherein the change in the number of the touched spots on the touchpad occurs within a predetermined time period.

25. The cursor-generating device as claimed in claim 16, wherein said processing unit enables generation of the cursor extension on the screen when the number of the touched spots on the touchpad detected by said detecting unit changes from two to one.

26. The cursor-generating device as claimed in claim 25, wherein said processing unit enables generation of the cursor extension at a position on the screen that corresponds to a vanished one of the touched spots, and further enables manipulation of the cursor extension through a remaining one of the touched spots on the touchpad.

27. The cursor-generating device as claimed in claim 25, wherein said processing unit is further operable so as to adjust a distance between the cursor extension generated on the screen and a position on the screen that corresponds to the remaining one of the touched spots based on a change in an area of the remaining one of the touched spots on the touchpad.

28. The cursor-generating device as claimed in claim 16, wherein said processing unit enables generation of the cursor extension on the screen when an area of the touched spot detected by said detecting unit on the touchpad exceeds a corresponding predetermined threshold.

29. The cursor-generating device as claimed in claim 28, wherein said processing unit is further operable so as to adjust a distance between the cursor extension generated on the screen and a position on the screen that corresponds to the touched spot detected by said detecting unit based on a change in the area of the touched spot on the touchpad.

30. A computer program product comprising:
a machine readable storage medium having program instructions stored therein which when executed cause a cursor-generating device to perform a set of operations including:
detecting presence of at least one touched spot on a touchpad of an electronic device; and
deciding whether to generate a cursor extension on a screen of the electronic device based on an attribute of the at least one detected touched spot.
